(19) United States
(12) Patent Application Publication
(10) Pub. No.: US 2026/0349975 A1
(43) Pub. Date: Nov. 5, 2026

(54) STORE DEDUPLICATION PROCESSING METHOD, APPARATUS AND DEVICE, AND STORAGE MEDIUM

(71) Applicant: CHINA UNIONPAY CO., LTD., Shanghai (CN)

(72) Inventors: Weiqi YU, Shanghai (CN); Xiaohan SHE, Shanghai (CN); Zehua ZENG, Shanghai (CN); Hua JIANG, Shanghai (CN); Pengfei GAO, Shanghai (CN); Sishuang WAN, Shanghai (CN); Lan LIU, Shanghai (CN)

(21) Appl. No.: 19/102,714

(22) PCT Filed: Feb. 7, 2023
(86) PCT No.: PCT/CN2023/074805

§ 371 Date: Feb. 10, 2025

(30) Foreign Application Priority Data
Aug. 10, 2022 (CN) 202210957641.0

(51) Int. Cl. G06F 16/215; G06Q 30/0204

(52) U.S. Cl. CPC G06F 16/215; G06Q 30/0205

(57) ABSTRACT

The present application discloses a store deduplication processing method, apparatus, device, and storage medium. The method comprises: obtaining a first store name and first store location information of a target store; determining, according to the first store location information, a target grid area where the target store is located; obtaining, from a pre-saved existing store database, a second store name and a second store location information of existing stores located in the target grid area and neighboring grid areas adjacent to the target grid area; obtaining a target similarity between the target store and the existing stores located in the target grid area and the neighboring grid areas according to the first store name and store location information, the second store name and store location information; removing the target store as a duplicate store when the target similarity is greater than or equal to a preset deduplication similarity threshold.

### CROSS REFERENCE TO RELATED APPLICATION

The present application claims priority to Chinese patent application No. 202210957641.0, entitled “STORE DEDUPLICATION PROCESSING METHOD, APPARATUS AND DEVICE, AND STORAGE MEDIUM” filed on Aug. 10, 2022, which is incorporated by reference in its entirety.

### TECHNICAL FIELD

The present application belongs to the field of data processing, and in particular, relates to a store deduplication processing method, apparatus and device, and a storage medium.

### BACKGROUND

With the promotion of electronic payment technology, users can use the electronic payment technology for payments in merchants' off-line stores. In order to facilitate the processing of electronic payment in merchants' off-line stores, information management is required for the merchants' off-line stores. However, when store data is sent from different sources, the different sources may send the store data of the same store, and the store data of the same store sent from the different sources may be different. As a result, the same store is erroneously determined as two different stores according to the store data, that is, the same store is repeatedly counted.

In order to avoid repeatedly counting the same store, personnel are dispatched to the store site for inspection to manually determine whether the same store has been repeatedly counted. The manual inspection takes a lot of time and manpower, and the efficiency of store deduplication processing is very low.

### SUMMARY

Embodiments of the present application provide a store deduplication processing method, apparatus and device, and a storage medium, which can improve the efficiency of store deduplication processing.

In a first aspect, embodiments of the present application provide a store deduplication processing method, including: obtaining a first store name and first store location information of a target store; determining, according to the first store location information, a target grid area where the target store is located; obtaining, from a pre-saved existing store database, a second store name and second store location information of an existing store located in the target grid area and neighboring grid areas, where the neighboring grid areas are adjacent to the target grid area; obtaining a target similarity between the target store and the existing store located in the target grid area and the neighboring grid areas according to the first store name, the first store location information, the second store name, and the second store location information; and removing the target store as a duplicate store when the target similarity is greater than or equal to a preset deduplication similarity threshold.

In a second aspect, the embodiments of the present application provide a store deduplication processing apparatus, including: a first obtaining module, configured to obtain a first store name and first store location information of a target store; a grid area determination module, configured to determine, according to the first store location information, a target grid area where the target store is located; a second obtaining module, configured to obtain, from a pre-saved existing store database, a second store name and second store location information of an existing store located in the target grid area and neighboring grid areas, where the neighboring grid areas are adjacent to the target grid area; a calculation module, configured to obtain a target similarity between the target store and the existing store located in the target grid area and the neighboring grid areas according to the first store name, the first store location information, the second store name, and the second store location information; and a deduplication module, configured to remove the target store as a duplicate store when the target similarity is greater than or equal to a preset deduplication similarity threshold.

In a third aspect, the embodiments of the present application provide a store deduplication processing device, including: a processor and a memory storing computer program instructions, where the processor implements the store deduplication processing method in the first aspect when executing the computer program instructions.

In a fourth aspect, the embodiments of the present application provide a computer-readable storage medium, storing computer program instructions that, when executed by a processor, implement the store deduplication processing method in the first aspect.

The embodiments of the present application provide the store deduplication processing method, apparatus and device, and the storage medium. The grid area where the target store is located can be determined according to the store location information of the target store. The grid area is an area obtained by dividing a map. A similarity between the target store and an existing store is obtained according to the store names and store location information, in a database, of existing stores located in the target grid area where the target store is located, and existing stores located in the grid areas surrounding the target grid area, as well the target store; whether a newly obtained store and the existing store are the same store is determined according to the similarity; if the newly obtained store and the existing store are the same store, it is considered that the newly obtained store is a duplicate store and should be removed. The deduplication process does not require manual involvement, and the location of a store is utilized to reduce the range of existing stores for comparison, thereby improving the efficiency of store deduplication processing.

### BRIEF DESCRIPTION OF THE DRAWINGS

In order to explain the technical solutions of the embodiments of the present application more clearly, the accompanying drawings required for use in the embodiments of the present application will be briefly introduced below. Those of ordinary skill in the art can derive other drawings according to the accompanying drawings without any creative effort.

FIG. 1 is a flowchart of a store deduplication processing method provided in an embodiment of the present application;

FIG. 2 is a schematic view of an example of grid areas in an embodiment of the present application;

FIG. 3 is a flowchart of a store deduplication processing method provided in another embodiment of the present application;

FIG. 4 is a schematic view of an example of a code table in an embodiment of the present application;

FIG. 5 is a flowchart of a store deduplication processing method provided in still another embodiment of the present application;

FIG. 6 is a schematic structural view of a store deduplication processing apparatus provided in an embodiment of the present application; and

FIG. 7 is a schematic structural view of a store deduplication processing device provided in an embodiment of the present application.

### DETAILED DESCRIPTION

Features and exemplary embodiments of various aspects of the present application will be described in detail below. In order to make the objectives, technical solutions, and advantages of the present application clearer, the present application will be further described in detail below with reference to the accompanying drawings and specific embodiments. It should be understood that the specific embodiments described here are only intended to explain the present application, but not to limit the present application. For those skilled in the art, the present application can be implemented without some of these specific details. The following descriptions of the embodiments are merely for providing a better understanding of the present invention by showing examples of the present invention.

With the promotion of electronic payment technology, users can use the electronic payment technology for payment in merchants' off-line stores. In order to facilitate the processing of electronic payments in merchants' off-line stores, information management is required for the merchants' off-line stores. However, when store data are sent from different sources, the different sources may send the store data of the same store, and the store data of the same store sent from the different sources may be different. As a result, the same store is erroneously determined as two different stores according to the store data, that is, the same store is repeatedly counted. In some cases, the repeated counting of the same store may also be exploited, resulting in vulnerabilities in the database that stores store information.

In order to avoid repeatedly counting the same store, personnel are dispatched to the store site for inspection to manually determine whether the same store has been repeatedly counted. The manual inspection takes a lot of time and manpower, and the efficiency of store deduplication processing is very low.

The present application provides a store deduplication processing method, apparatus and device, and a storage medium, which can determine, according to newly obtained store location information of a store, a grid area where the store is located. The grid area is an area divided in a map. A similarity between the newly obtained store and an existing store is obtained using data of the existing store in a target grid area where the newly obtained store is located and a grid area surrounding the target grid area in a database, as well as data of the newly obtained store, whether the newly obtained store and the existing store are the same store is determined according to the similarity, and if the newly obtained store and the existing store are the same store, it is considered that the newly obtained store is a duplicate store and should be removed. The deduplication process does not require manual involvement, and the location of a store is utilized to reduce the range of existing stores for comparison, thereby improving the efficiency of store deduplication processing.

Explanations of the store deduplication processing method, apparatus and device, and the storage medium provided in the present application are made herein.

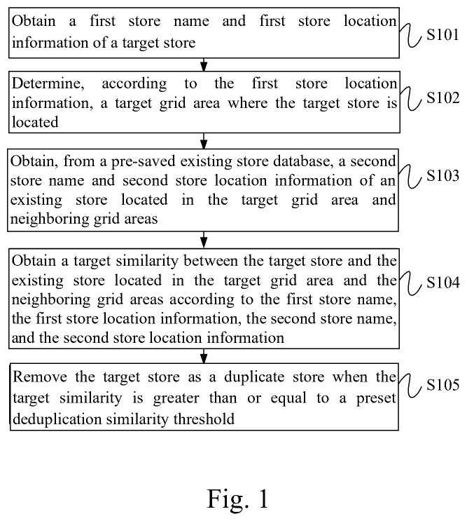

A first aspect of the present application provides a store deduplication processing method, which can be applied to scenarios of store deduplication according to store information collected from different sources, and which can be executed by a store deduplication apparatus or device, but not limited herein. FIG. 1 is a flowchart of a store deduplication processing method provided in an embodiment of the present application. As shown in FIG. 1, the store deduplication processing method may include steps S101 to S105.

In step S101, a first store name and a first store location information of a target store are obtained.

The target store is a store to be determined as a duplicate store or not, and may be a store corresponding to newly obtained store information, such as a new store to be added to an existing store database. The first store name may be a store name of the target store. The first store location information may be store location information of the target store. The store location information is used for representing the location of a store, including store address, store latitude and longitude, etc., which are not limited here.

In step S102, according to the first store location information, a target grid area where the target store is located is determined.

For ease of processing, a map may be pre-divided into a plurality of grid areas. The sizes of different grid areas may be the same or different, which is not limited here. The shapes of the grid areas may be regular such as rectangle or irregular, which is not limited here. For example, the grid areas may be rectangular areas having a length of 150 meters and a width of 150 meters.

The target grid area is a grid area where the target store is located. The first store location information may represent the location of the target store, and a grid area where the target store is located, namely, the target grid area, may be determined according to the first store location information.

In step S103, from a pre-saved existing store database, a second store name and a second store location information of an existing store located in the target grid area and neighboring grid areas are obtained.

The existing store database includes relevant data of existing stores. The existing stores are stores that have been determined as non-duplicate stores. The relevant data of the existing stores may include, but is not limited to, store names and store location information of the existing stores, grid areas where the existing stores are located, etc.

In order to reduce the range of existing stores compared with the target store, a geographical area of one existing store that may be the same store as the target store can be first delineated according to its location, where the geographical area is a surrounding area of the location of the target store. The target grid area and the neighboring grid areas may be determined as surrounding areas of the location of the target store. The neighboring grid areas are adjacent to the target grid area, that is, the neighboring grid areas are grid areas adjacent to the target grid area.

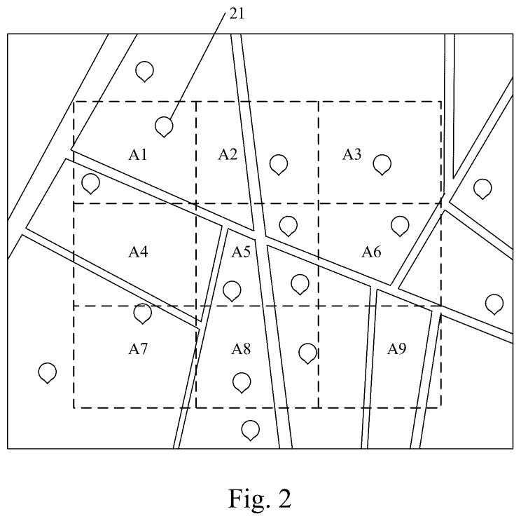

For example, FIG. 2 is a schematic view of an example of grid areas in an embodiment of the present application. In FIG. 2, dashed squares show 9 grid areas, namely, grid areas A1 to A9. FIG. 2 also shows a plurality of existing stores 21. If grid area A5 is the target grid area, correspondingly, grid area A1, grid area A2, grid area A3, grid area A4, grid area A6, grid area A7, grid area A8, and grid area A9 are all neighboring grid areas of the target grid area. Taking the target store located in grid area A5 as an example of deduplication processing, a store name and store location information of each existing store 21 in grid area A1, a store name and store location information of each existing store 21 in grid area A2, a store name and store location information of each existing store 21 in grid area A3, a store name and store location information of each existing store 21 in grid area A4, a store name and store location information of each existing store 21 in grid area A6, a store name and store location information of each existing store 21 in grid area A7, a store name and store location information of each existing store 21 in grid area A8, and a store name and store location information of each existing store 21 in grid area A9 can be obtained.

The number of existing stores in the existing store database is very large. If the target store is compared with all the existing stores in the existing store database one by one, it will take a relatively long time for store deduplication processing. Because the target grid area and the neighboring grid areas are surrounding areas of the target store, there is a high possibility that an existing store located in the surrounding areas of the target store and the target store actually are the same store. Relevant data of the existing store located in the target grid area and the neighboring grid areas in the existing store database can be selected out first, and the existing store is compared with the target store using the relevant data of the existing store located in the target grid area and the neighboring grid areas and relevant data of the target store, to shorten the time required for store deduplication processing and improve the efficiency of store deduplication processing.

The existing stores located in the target grid area and the neighboring grid areas include existing stores located in the target grid area and existing stores located in the neighboring grid areas. The second store names include store names of the existing stores located in the target grid area and store names of the existing stores located in the neighboring grid areas. The second store location information includes store location information of the existing stores located in the target grid area and store location information of the existing stores located in neighboring grid areas.

In step S104, a target similarity between the target store and the existing store located in the target grid area and the neighboring grid areas are obtained according to the first store name, the first store location information, the second store name, and the second store location information.

A similarity in store names between the target store and the existing store can be obtained according to the first store name and the second store name. A similarity in geographical locations between the target store and the existing store can be obtained according to the first store location information and the second store location information. The target similarity can be obtained according to the similarity in store names and the similarity in geographical locations between the target store and the existing store. The target similarity refers to a similarity between the target store and the existing store. A similarity between the target store and each existing store located in the target grid area and the neighboring grid areas can be calculated, and it is determined according to the target similarity whether the target store is a duplicate store that is the same as the existing store located in the target grid area and the neighboring grid areas.

In step S105, the target store as a duplicate store is removed in the case that the target similarity is greater than or equal to a preset deduplication similarity threshold.

The deduplication similarity threshold is a threshold of similarity for confirming the target store and the existing store as the same store, and can be set according to the scenario, demand, experience, etc., which is not limited herein. For example, the deduplication similarity threshold may be 0.6. If the target similarity is greater than or equal to the deduplication similarity threshold, it indicates that the target store and the existing store are the same store, that is, the target store is a duplicate store and can be removed. By removing the target store it may be meant discarding the relevant data of the target store. If the target similarity is less than the deduplication similarity threshold, it indicates that the target store and the existing store are different stores, that is, the target store is not a duplicate store. The relevant data of the target store can be saved in the existing store database, that is, the target store can be regarded as a newly added existing store in the existing store database.

In the embodiments of the present application, the grid area where the target store is located can be determined according to the store location information of the target store. The grid area is an area divided in a map. A similarity between the target store and an existing store is obtained according to the store names and store location information, in a database, of existing stores located in the target grid area where the target store is located, and existing stores located in the grid areas surrounding the target grid area, as well those of the target store; whether a newly obtained store and the existing store are the same store is determined according to the similarity; if the newly obtained store and the existing store are the same store, it is considered that the newly obtained store is a duplicate store and should be removed. The deduplication process does not require manual involvement, and the location of a store is utilized to reduce the range of existing stores for comparison, thereby improving the efficiency of store deduplication processing.

Moreover, in addition to comparing the target store with the existing stores in the target grid area, the target store can also be compared with the existing stores in the neighboring grid areas, thereby avoiding missing existing stores that are located near the boundary of the target grid area and are the same store as the target store, and further improving the comprehensiveness and accuracy of store deduplication processing.

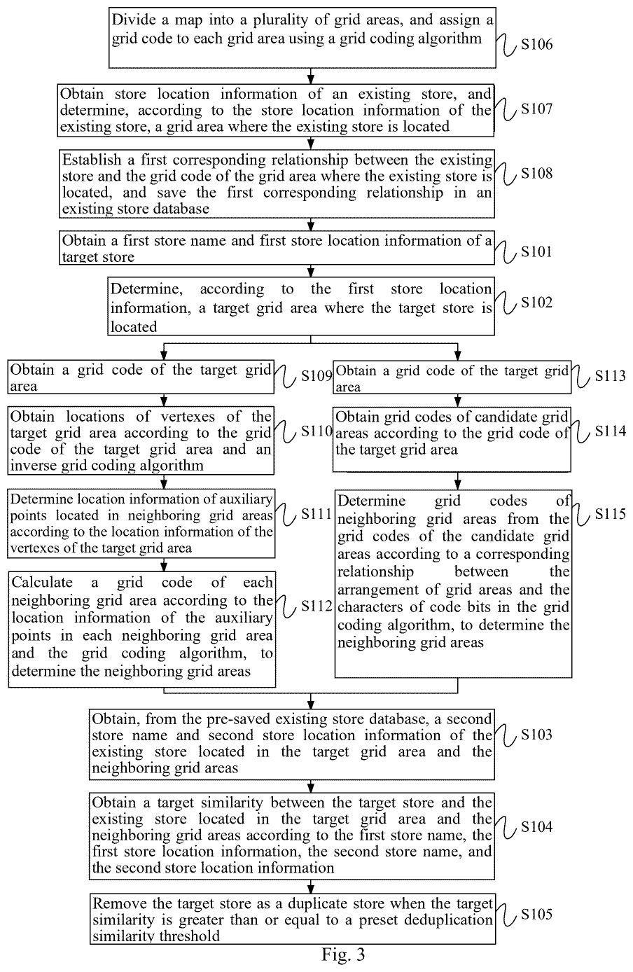

In some embodiments, the grid area has a grid code, and the neighboring grid areas of the target grid area can be determined according to the grid code of the target grid area and a grid coding algorithm. FIG. 3 is a flowchart of a store deduplication processing method provided in another embodiment of the present application. FIG. 3 differs from FIG. 1 in that the store deduplication processing method shown in FIG. 3 may further include steps S106 to S108, and the store deduplication processing method shown in FIG. 3 may further include steps S109 to S112, or steps S113 to S115.

In step S106, a map is divided into a plurality of grid areas, and a grid code is assigned to each grid area using a grid coding algorithm.

A geographical map may be obtained and divided into a plurality of grid areas. A grid code is assigned to each grid area. The grid code may represent a grid area, that is, different grid areas have different grid codes. The grid code can be obtained according to the grid coding algorithm. The type of the grid coding algorithm is not limited here. The same grid code is calculated according to the location information of different positions in the same grid area.

In some examples, the grid code may be an m-bit character string, and the first m1 bits of characters in the grid code may represent a province, a city, a district, etc. The first m1 bits of a plurality of neighboring grid areas have the same characters, while the last m-m1 bits have different characters. The last m-m1 bits of characters of the grid codes in different grid areas may be selected according to a preset code table. The preset code table includes a plurality of code characters arranged in a certain order. Corresponding code characters may be selected as the last m-m1 bits of characters of the grid codes according to the arrangement order of the code characters and the corresponding relationship between the grid areas. Each bit among the last m-m1 bits of the grid code may correspond to a code table, and the code tables corresponding to different bits may be the same or different. Whether the plurality of grid areas are adjacent can be determined according to the grid codes of the plurality of grid areas. Further, the orientation relationship between the grid areas can be determined according to the grid codes of the plurality of grid areas.

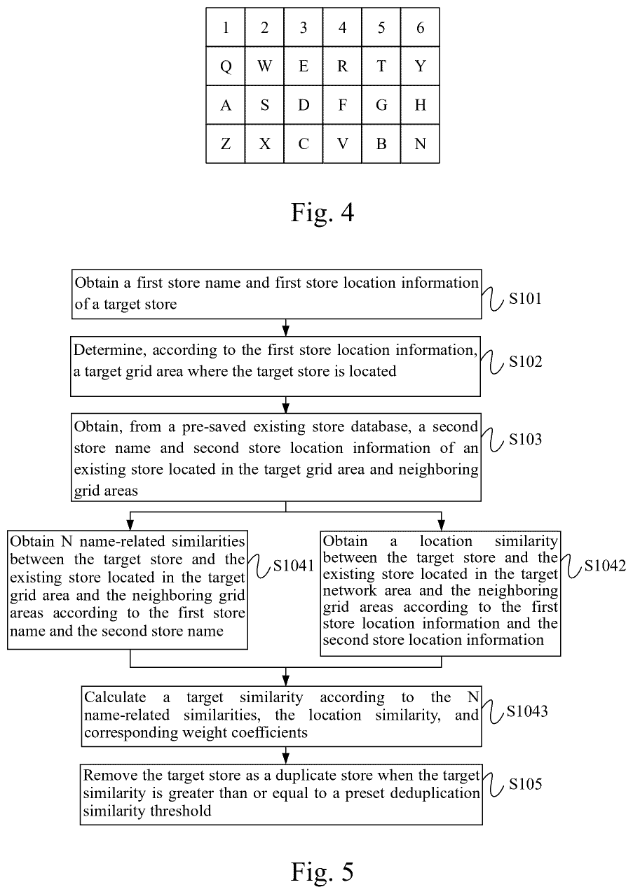

For example, FIG. 4 is a schematic view of an example of a code table in an embodiment of the present application. The grid areas are shown in FIG. 2, and the grid code is a 7-bit character string. If the first 6 bits of characters in the grid codes of the neighboring grid areas are consistent and are all wk2vu1, their last bit of character is coded according to the code table shown in FIG. 4. The grid code of grid area A1 is wk2vu1E, the grid code of grid area A2 is wk2vu1R, the grid code of grid area A3 is wk2vu1T, the grid code of grid area A4 is wk2vu1D, the grid code of grid area A5 is wk2vu1F, the grid code of grid area A6 is wk2vu1G, the grid code of grid area A7 is wk2vu1C, the grid code of grid area A8 is wk2vu1V, and the grid code of grid area A9 is wk2vu1B.

In step S107, store location information of an existing store is obtained, and, according to the store location information of the existing store, a grid area where the existing store is located is determined.

In step S108, a first corresponding relationship between the existing store and the grid code of the grid area where the existing store is located is established, and the first corresponding relationship is saved in an existing store database.

The first corresponding relationship includes a corresponding relationship between the existing store and the grid code of the grid area where the existing store is located. In order to further shorten the time required for store deduplication processing, data of each existing store may be pre-processed, a corresponding relationship is established between the grid code of the obtained grid area where the existing store is located and the existing store, and the corresponding relationship is saved in the existing store database, such that existing stores corresponding to the grid code of a target grid area and existing stores corresponding to the grid codes of neighboring grid areas can be directly found in the existing store database in the store deduplication process, where the existing stores corresponding to the grid code of the target grid area are existing stores located in the target grid area, and the existing stores corresponding to the grid codes of the neighboring grid areas are existing stores located in the neighboring grid areas.

In step S109, a grid code of the target grid area is obtained.

After the target grid area is determined, the grid code of the target grid area can be obtained.

In step S110, locations of vertexes of the target grid area are obtained according to the grid code of the target grid area and an inverse grid coding algorithm.

The inverse grid coding algorithm is an inverse algorithm of the grid coding algorithm. According to the location information of one or more locations in a grid area, the grid code of the grid area can be obtained using the grid coding algorithm. According to the grid code of a grid area, the location information of the vertexes of the grid area can be obtained using the inverse grid coding algorithm.

In step S111, location information of auxiliary points located in neighboring grid areas is determined according to the location information of the vertexes of the target grid area.

The neighboring grid areas share some vertexes with the target grid area. Obtaining the location information of the vertexes of the target grid area is equivalent to obtaining the location information of some vertexes of the neighboring grid areas. The location information of the auxiliary points in the neighboring grid areas can be obtained according to the location information of some vertexes of the neighboring grid areas. The auxiliary points may be any one or more points in the neighboring grid areas except the vertexes shared with the target grid area, which is not limited here. The auxiliary points can be determined in each neighboring grid area for subsequent use of their location information to determine the neighboring grid areas.

In step S112, a grid code of each neighboring grid area is calculated according to the location information of the auxiliary points in each neighboring grid area and the grid coding algorithm, to determine the neighboring grid areas.

Grid codes have a corresponding relationship with grid areas. The grid codes, calculated according to the location information of the auxiliary points in the neighboring grid areas by the grid coding algorithm, are grid codes of the neighboring grid areas. The neighboring grid areas can be determined using the corresponding relationship between the grid codes and the grid areas.

In step S113, a grid code of the target grid area is obtained.

In step S114, grid codes of candidate grid areas are obtained according to the grid code of the target grid area.

In some examples, some bits of characters in the grid codes of the neighboring grid areas are the same. This feature can be used to select out grid areas adjacent to the target grid area from the large number of grid areas, namely, the candidate grid areas. The candidate grid areas include grid areas, some bits of characters in the grid codes of which are the same as those in the grid code of the target grid area. For example, if the first m1 bits of characters in the grid codes of the neighboring grid areas are the same, the grid areas, the first m1 bits of characters in the grid codes of which are the same as those in the grid code of the target grid area, can be determined as the candidate grid areas.

In step S115, grid codes of neighboring grid areas are determined from the grid codes of the candidate grid areas according to a corresponding relationship between the arrangement of grid areas and the characters of code bits in the grid coding algorithm, to determine the neighboring grid areas.

The grid coding algorithm may include the corresponding relationship between the arrangement of grid areas and the characters of code bits. For example, the arrangement of grid areas is shown in FIG. 2, the grid code is a 7-bit character string, the first 6 bits of characters of the grid codes of the candidate grid areas are the same as those of the grid code of the target grid area, the target grid area is grid area A5 and its grid code is wk2vu1D. The corresponding relationship between the arrangement of grid areas and the last bit of character of the grid code in the grid coding algorithm is specifically implemented in the code table shown in FIG. 4. Then it can be seen that the target grid area has 8 neighboring grid areas, and the 8 neighboring grid areas are located on the upper left, upper, upper right, left, right, lower left, lower, and lower right of the target grid area, respectively. According to the code table shown in FIG. 4, the characters on the upper left, upper, upper right, left, right, lower left, lower, and lower right of character D are W, E, R, S, F, X, C, and V, respectively. Correspondingly, the grid codes of the 8 neighboring grid areas located on the upper left, upper, upper right, left, right, lower left, lower, and lower right of the target grid area, namely, grid area A1, grid area A2, grid area A3, grid area A4, grid area A6, grid area A7, grid area A8, and grid area A9, are wk2vu1 W, wk2vu1E, wk2vu1R, wk2vu1S, wk2vu1F, wk2vu1X, wk2vu1C, and wk2vu1V, respectively.

A grid code characterizes a grid area. By determining the grid codes of the neighboring grid areas, the neighboring grid areas can be determined.

The method of determining the neighboring grid areas using the corresponding relationship between the arrangement of grid areas and the characters of code bits is simpler, less time-consuming, and more efficient.

In some embodiments, the target similarity may be obtained by combining similarities related to the store name and similarities related to the store location information. FIG. 5 is a flowchart of a store deduplication processing method provided in still another embodiment of the present application. FIG. 5 differs from FIG. 1 in that step S104 in FIG. 1 can be specifically refined into steps S1041 to S1043 in FIG. 5.

In step S1041, N name-related similarities between the target store and the existing store located in the target grid area and the neighboring grid areas are obtained according to the first store name and the second store name.

N is an integer greater than or equal to 1. The name-related similarities refers to similarities related to store names, and can be obtained according to the first store name and the second store name. The name-related similarities may include, but are not limited to, any one or more of a character similarity, a semantic similarity, and a store type similarity. The character similarity refers to a similarity between characters that form store names. The semantic similarity refers to a similarity between semantics of the store names. The store type similarity refers to a similarity between store types obtained from the store names.

In some examples, the name-related similarities include a character similarity. The first store name and the second store name can be segmented respectively to obtain terms corresponding to the first store name and terms corresponding to the second store name; term frequencies (TFs) and inverse document frequencies (IDFs) of the terms corresponding to the first store name and the terms corresponding to the second store name are calculated; the terms with term frequencies less than or equal to a redundant term frequency threshold and inverse document frequencies greater than a redundant frequency threshold are selected; the character similarity between the target store and the existing store located in the target grid area and the neighboring grid areas is obtained according to the selected terms corresponding to the first store name and the selected terms corresponding to the second store name.

The first store name can be segmented with a word segmentation tool to obtain the terms corresponding to the first store name; and the second store name are segmented with the segmentation tool to obtain the terms corresponding to the second store name. The term frequency represents a frequency of occurrence of a term. The inverse document frequency is used for representing the distinguishing ability of the term. The redundant term frequency threshold is a threshold of term frequencies for distinguishing whether the term is a redundant term. The redundant frequency threshold is a threshold of inverse document frequencies for distinguishing whether the term is a redundant term. If the term frequency of a term is greater than the redundant term frequency threshold, it indicates that the term is a redundant term. If the inverse document frequency of a term is less than or equal to the redundancy frequency threshold, it indicates that the term is a redundant term. Redundant terms are not helpful for calculating the character similarity and may even have adverse effects, so the redundant terms do not need to participate in the calculation of the character similarity. The terms with term frequencies less than or equal to the redundant term frequency threshold and inverse document frequencies greater than the redundant frequency threshold are valid terms that participate in the calculation of the character similarity, The calculation of the character similarity may refer to the bilingual evaluation understudy (BLEU) algorithm used in machine translation, which evaluates the similarity in characters between the first store name and the second store name by N-gram overlaps between the selected terms corresponding to the first store name and the selected terms corresponding to the second store name.

In some examples, the name-related similarities include a semantic similarity. The first store name and the second store name are transformed into a first name digit sequence and a second name digit sequence respectively; the first name digit sequence and the second name digit sequence are input into a first model, to obtain the semantic similarity between the target store and the existing store located in the target grid area and the neighboring grid areas output by the first model.

The first model is used for outputting the semantic similarity between two store names according to the input digit sequences transformed from the two store names. A certain quantity of labeled store names may be pre-obtained as positive samples of a training set, an equivalent quantity of store names are randomly selected as negative samples of the training set, the positive samples of the training set and the negative samples of the training set are transformed into digit sequences respectively, and the first model is trained using the digit sequences. The first model may include a classification model. The classification model may be a deep learning classification model or other types of classification models, which are not limited here. For example, a BERT (Bidirectional Encoder Representations from Transformer) model can be used to train the first model by “[CLS]+the digit sequence corresponding to one store name+ [September]+the digit sequence corresponding to another store name” as the input, such that the first model can fit the semantic similarity between one store name and another store name, that is, the first model can output the semantic similarity between one store name and another store name according to the input.

The first name digit sequence is a digit sequence transformed from the first store name. The second name digit sequence is a digit sequence transformed from the second store name. Specifically, the store name can be segmented by characters, the segmented characters are transformed into digits, and the digits corresponding to each character are combined to obtain a digit sequence. The first name digit sequence and the second name digit sequence corresponding to one existing store located in the target grid area and the neighboring grid area are input into the first model, and the first model can output the semantic similarity between the store name of the target store and the store name of this existing store.

In some examples, the name-related similarities include a store type similarity. In the process of store deduplication, there may be a possibility of false deduplication caused by the fact that stores are chain stores and are close to each other and different store names are similar. In order to reduce or even avoid the possibility of false deduplication, the store type similarity can be introduced to improve the accuracy of store deduplication. The first store name information can be obtained according to the first store name; the first store name information is input into a second model to obtain a store type probability vector of the target store output by the second model; a store type probability vector corresponding to the second store name is searched in the stock database; a similarity between the store type probability vector of the target store and the store type probability vector corresponding to the second store name is calculated, and the similarity is determined as the store type similarity between the target store and the existing store located in the target grid area and the neighboring grid areas.

The second model is used for outputting a store type probability vector according to the input store name information. The store type probability vector is used for representing a probability that the store indicated by the store name belongs to each store type. Each element in the store type probability vector may represent a probability that the store belongs to one store type. The store type corresponding to the element representing the highest probability in the store type probability vector may be determined as the store type of the store. The store type probability vector may be, but is not limited to, a normalized vector having a length of M. A certain quantity of labeled store names and types may be pre-obtained as a training set, such as <XXXX1 (B1 district store), supermarket> and <YYYY2 (B2 district store), coffee shop>, where XXXX1 (B1 district store) and YYYY2 (B2 district store) are store names, supermarket and coffee shop are store types. The second model is obtained by training the training set. The second model may include a classification model. The classification model may be a deep learning classification model or other types of classification models, which are not limited here. For example, a BERT model can be used to train the second model by “[CLS]+the digit sequence corresponding to one store name” as the input, such that the second model can fit the corresponding relationship between the store name and the store type, that is, the second model can output the store type probability vector of the store name according to the input.

The first store name information is obtained according to the first store name, and may be the first store name or information about the first store name after processing, such as a digit sequence. The transformation of the store name into the digit sequence can refer to relevant explanation in the above embodiment, which will not be repeated here. The store type probability vector corresponding to the second store name includes a store type probability vector corresponding to the existing store located in the target grid area and the neighboring grid areas. In some examples, the similarity between the store type probability vector of the target store and the store type probability vector corresponding to the second store name may be a cosine similarity between the two store type probability vectors.

In order to further shorten the time required for store deduplication processing, the store type probability vector of each existing store can be pre-obtained according to the store name of the existing store, such that store type probability vectors can be directly obtained from the existing store database when a store type similarity is calculated. Specifically, a store name of the existing store is obtained, and store name information is obtained according to the store name; the store name information of the existing store is input into the second model to obtain a store type probability vector of the existing store output by the second model; a second corresponding relationship between the existing store and the store type probability vector of the existing store is established, and the second corresponding relationship is saved in the existing store database. When the store type similarity is calculated, the store type probability vector corresponding to the second store name can be found in the existing store database according to the second corresponding relationship.

In step S1042, a location similarity between the target store and the existing store located in the target network area and the neighboring grid areas is obtained according to the first store location information and the second store location information.

The location similarity refers to a similarity related to store location information, and can be obtained according to the first store location information and the second store location information. The location similarity can be determined according to a distance between two store locations indicated by the two pieces of store location information and a deviation value that may be caused by the location information. Specifically, a geographical distance between the target store and the existing store is obtained according to the first store location information and the second store location information; and the location similarity between the target store and the existing store located in the target network area and the neighboring grid areas is obtained according to a ratio of the geographical distance to a location deviation threshold. The first store location information and the second store may be positioning coordinate information, such as global positioning system (GPS) coordinate information. If the first store location information and the second store location information are address information, the address information can be transformed into coordinate information, such as latitude and longitude information, and then the geographical distance between the target store and the existing store can be determined according to the coordinate information. The position deviation threshold can be a maximum deviation value that may be caused by location information. The ratio of the geographical distance to the location deviation threshold can be normalized to obtain the location similarity. For example, the location similarity can be obtained according to formula (1) below:

$$1 - \frac{geographical distance}{location deviation threshold} \qquad ( 1 )$$

In step S1043, a target similarity is calculated according to the N name-related similarities, the location similarity, and corresponding weight coefficients.

The weight coefficients may be used as indexes or product coefficients to participate in the calculation of the target similarity, and are not limited here. In some examples, the weight coefficients may be used as indexes to participate in the calculation of the target similarity. For example, the name-related similarities include a character similarity, a semantic similarity, and a store type similarity. The target similarity can be obtained according to formula (2) below:

sim(target store,existing store)=sim(character)^{α}×sim(semantic)^{β}×sim(type)^{γ}×sim(location)^{δ} (2)
where sim (target store, existing store) represents the target similarity; sim (character) represents the character similarity; sim (semantic) represents the semantic similarity; sim (type) represents the store type similarity; sim (location) represents the location similarity; α represents a weight coefficient of the character similarity; β represents a weight coefficient of the semantic similarity; γ represents a weight coefficient of the store type similarity; δ represents a weight coefficient of the location similarity. In some examples, for ease of calculation, α=β=γ=δ=1.

For ease of understanding, the store deduplication processing method is illustrated below by an example. In this example, the name-related similarities include a character similarity, a semantic similarity, and a store type similarity.

A store name and a store address of a target store are obtained, and the store address is transformed into latitude and longitude coordinates {30.193, 120.173}. A grid code of a grid area where the target store is located, namely, a target grid area, is calculated using a grid coding algorithm to obtain wtm7y8e. First 6 bits of characters of grid codes of neighboring grid areas are the same as those of the grid code of the target grid area. The grid codes of 8 neighboring grid areas can be obtained using the code table shown in FIG. 4. The grid codes of the 8 neighboring grid areas are wtm7y82, wtm7y83, wtm7y84, wtm7y8 W, wtm7y8R, wtm7y8S, wtm7y8D, and wtm7y8F, respectively. By searching in an existing store database, it is determined that there are 158 existing stores in the target grid area, 0 existing store in the neighboring grid area with grid code wtm7y82, 4 existing stores in the neighboring grid area with grid code wtm7y83, 1 existing store in the neighboring grid area with grid code wtm7y84, 0 existing store in the neighboring grid area with grid code wtm7y8 W, 18 existing stores in the neighboring grid area with grid code wtm7y8R, 1 existing store in the neighboring grid area with grid code wtm7y8S, 0 existing store in the neighboring grid area with grid code wtm7y8D, and 0 existing store in the neighboring grid area with grid code wtm7y8F. That is, there are totally 181 existing stores in the target grid area and the neighboring grid areas. A target similarity between the target store and each existing store in the target grid area and the neighboring grid areas needs to be calculated.

The calculation of the target similarity between the target store and one of the existing stores is taken as an example for explanation below. The store name of the target store is “X1X2 (Hangzhou Binjiang Baolong City Square Store)”, and the existing store name is “Hangzhou Binjiang District X3X4 Convenience Store”, where X1, X2, X3, and X4 are all Chinese characters and are different Chinese characters.

The store names of the target store and the existing store can be segmented with a word segmentation tool to obtain terms corresponding to the target store and terms corresponding to the existing store. The terms corresponding to the target store include ‘X1X2’, ‘(‘, Hangzhou’, ‘Binjiang’, ‘Baolong’, ‘City’, ‘Square’, ‘Store’, and’)’. The terms corresponding to the existing store include ‘Hangzhou’, ‘Binjiang District’, ‘X3X4’, and ‘Convenience Store’. A term frequency and an inverse document frequency of each term are calculated. The term frequencies and inverse document frequencies of ‘(‘, ‘Hangzhou’, and’)’ in the above terms do not satisfy a condition that the term frequency is less than or equal to a redundant term frequency threshold and the inverse document frequency is greater than a redundant frequency threshold, so the terms ‘(‘, ‘Hangzhou’, and’)’ are discarded. After the terms ‘(‘, ‘Hangzhou’, and’)’ are discarded, the selected terms corresponding to the target store are combined to obtain “X1X2 Binjiang Baolong City Square Store”, and the selected terms corresponding to the existing store are combined to obtain “Binjiang District X3X4 Convenience Store”. A character similarity is calculated using the aforementioned BLEU algorithm. “X1X2 Binjiang Baolong City Square Store” includes eleven 1-grams, “Binjiang District X3X4 Convenience Store” includes eight 1-grams, and numbers of co-occurrence of the 1-grams of the two are calculated respectively, where the three 1-grams ‘Bin’, ‘jiang’ and ‘Store’ co-occur once respectively. Therefore, the character similarity between “X1X2 Binjiang Baolong City Square Store” and “Binjiang District X3X4 Convenience Store” is (3/11+3/8)/2≈0.32.

“X1X2 (Hangzhou Binjiang Baolong City Square Store)” can be transformed into a digit sequence [0, 1, 2, 3, 4, 5, 6, 7, 8, 9, 10, 11, 12, 13, 14, 15], and “Hangzhou Binjiang District X3X4 Convenience Store” can be transformed into a digit sequence [3, 4, 5, 6, 7, 16, 17, 18, 19, 20, 14], where the same Chinese characters correspond to the same digits. The above two digit sequences are spliced with [CLS] and [September] and combined into single vectors, which are input into the first model to obtain a semantic similarity between the two output by the first model.

The two digit sequences transformed from “X1X2 (Hangzhou Binjiang Baolong City Square Store)” and “Hangzhou Binjiang District X3X4 Convenience Store” can be input into the second model respectively to obtain a store type probability vector of the target store and a store type probability vector of the existing store. The target store and the existing store have relatively high values of elements in three store type dimensions of “shopping”, “supermarket”, and “convenience store”. The store types represented by the store type similarity between the store type probability vector of the target store and the store type probability vector of the existing store are relatively close.

A geographical distance between the two is determined to obtain 285 meters according to the store location information of the target store and the store location information of the existing store, and a location similarity can be calculated to obtain 0.8585 according to the geographical distance and a location deviation threshold.

Assuming the deduplication similarity threshold is 0.6, for the target store and the existing store, a target similarity calculated by formula (2) is less than 0.6. Therefore, it can be determined that the target store and the existing store are not the same store.

It should be noted that the obtaining, saving, use, processing, etc. of information and data in the embodiments of the present application are authorized by users or relevant institutions and comply with relevant national laws and regulations.

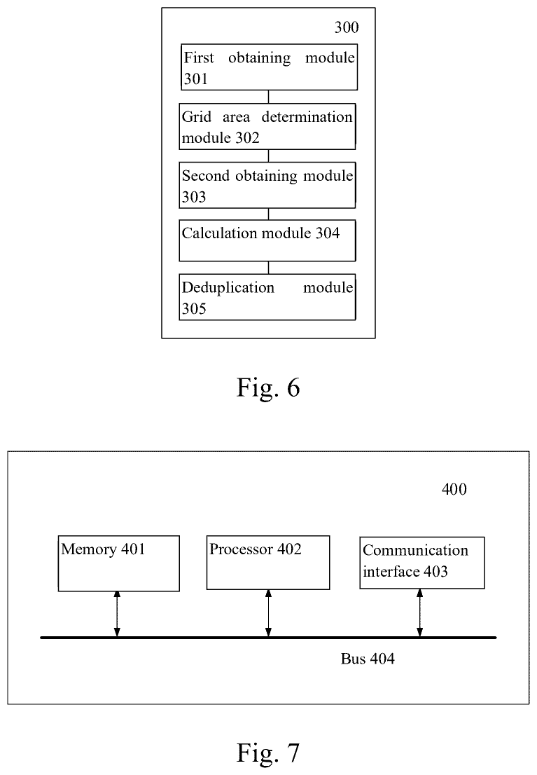

A second aspect of the present application provides a store deduplication processing apparatus. FIG. 6 is a schematic structural view of a store deduplication processing apparatus provided in an embodiment of the present application. As shown in FIG. 6, the store deduplication processing apparatus 300 may include a first obtaining module 301, a grid area determination module 302, a second obtaining module 303, a calculation module 304, and a deduplication module 305.

The first obtaining module 301 may be configured to obtain a first store name and first store location information of a target store.

The grid area determination module 302 may be configured to determine, according to the first store location information, a target grid area where the target store is located.

The second obtaining module 303 may be configured to obtain, from a pre-saved existing store database, a second store name and second store location information of an existing store located in the target grid area and neighboring grid areas.

The neighboring grid areas are adjacent to the target grid area.

The calculation module 304 may be configured to obtain a target similarity between the target store and the existing store located in the target grid area and the neighboring grid areas according to the first store name, the first store location information, the second store name, and the second store location information.

The deduplication module 305 may be configured to remove the target store as a duplicate store when the target similarity is greater than or equal to a preset deduplication similarity threshold.

In the embodiments of the present application, the grid area where the target store is located can be determined according to the store location information of the target store. The grid area is an area obtaining by dividing a map. A similarity between the target store and an existing store is obtained according to the store names and store location information, in a database, of existing stores located in the target grid area where the target store is located, and existing stores located in the grid areas surrounding the target grid area, as well those of the target store; whether a newly obtained store and the existing store are the same store is determined according to the similarity; if the newly obtained store and the existing store are the same store, it is considered that the newly obtained store is a duplicate store and should be removed. The deduplication process does not require manual involvement, and the location of a store is utilized to reduce the range of existing stores for comparison, thereby improving the efficiency of store deduplication processing.

Moreover, in addition to comparing the target store with the existing stores in the target grid area, the target store can also be compared with the existing stores in the neighboring grid areas, thereby avoiding missing existing stores that are located near the boundary of the target grid area and are the same store as the target store, and further improving the comprehensiveness and accuracy of store deduplication processing.

In some embodiments, each grid area has a grid code. The store deduplication processing apparatus 300 may further include a neighboring grid area determination module.

In some examples, the neighboring grid area determination module may be configured to: obtain the grid code of the target grid area; obtain location information of vertexes of the target grid area according to the grid code of the target grid area and an inverse grid coding algorithm; determine location information of auxiliary points located in the neighboring grid areas according to the location information of the vertexes of the target grid area; and calculate the grid code of each neighboring grid area according to the location information of the auxiliary points in each neighboring grid area and a grid coding algorithm, to determine the neighboring grid areas.

In some examples, the values of some bits in the grid codes of the neighboring grid areas are the same. The neighboring grid area determination module may be configured to: obtain the grid code of the target grid area; obtain the grid codes of candidate grid areas according to the grid code of the target grid area, where the candidate grid areas include grid areas, some bits of characters in the grid codes of which are the same as those in the grid code of the target grid area; and determine the grid codes of the neighboring grid areas from the grid codes of the candidate grid areas according to a corresponding relationship between the arrangement of grid areas and the characters of code bits in the grid coding algorithm, to determine the neighboring grid areas.

In some embodiments, the store deduplication processing apparatus 300 may further include a first pre-processing module. The first pre-processing module may be configured to: divide a map into a plurality of grid areas, and assign a grid code to each grid area using the grid coding algorithm; obtain store location information of the existing store, and determine, according to the store location information of the existing store, a grid area where the existing store is located; establish a first corresponding relationship between the existing store and the grid code of the grid area where the existing store is located, and save the first corresponding relationship in the existing store database.

In some embodiments, the calculation module 304 may be configured to: obtain N name-related similarities between the target store and the existing store located in the target grid area and the neighboring grid areas according to the first store name and the second store name, where N is an integer greater than or equal to 1; obtain a location similarity between the target store and the existing store located in the target network area and the neighboring grid areas according to the first store location information and the second store location information; and calculate the target similarity according to the N name-related similarities, the location similarity, and corresponding weight coefficients.

In some examples, the name-related similarities include a character similarity. The calculation module 304 may be configured to: segment the first store name and the second store name respectively to obtain terms corresponding to the first store name and terms corresponding to the second store name; calculate term frequencies and inverse document frequencies of the terms corresponding to the first store name and the terms corresponding to the second store name; select the terms with term frequencies less than or equal to a redundant term frequency threshold and inverse document frequencies greater than a redundant frequency threshold; and obtain, according to the selected terms corresponding to the first store name and the selected terms corresponding to the second store name, the character similarity between the target store and the existing store located in the target grid area and the neighboring grid areas.

In some examples, the name-related similarities include a semantic similarity. The calculation module 304 may be configured to: transform the first store name and the second store name into a first name digit sequence and a second name digit sequence respectively; and input the first name digit sequence and the second name digit sequence into a first model, to obtain the semantic similarity between the target store and the existing store located in the target grid area and the neighboring grid areas output by the first model, where the first model is used for outputting the semantic similarity between two store names according to the input digit sequences transformed from the two store names.

In some examples, the name-related similarities include a store type similarity. The calculation module 304 may be configured to: obtain the first store name information according to the first store name; input the first store name information into a second model to obtain a store type probability vector of the target store output by the second model, where the second model is used for outputting a store type probability vector according to the input store name information, and the store type probability vector is used for representing a probability that the store indicated by the store name belongs to each store type; search in the stock database for a store type probability vector corresponding to the second store name; calculate a similarity between the store type probability vector of the target store and the store type probability vector corresponding to the second store name, and determine the similarity as the store type similarity between the target store and the existing store located in the target grid area and the neighboring grid areas.

In some examples, the calculation module 304 may be configured to: obtain a geographical distance between the target store and the existing store according to the first store location information and the second store location information; and obtain the location similarity between the target store and the existing store located in the target network area and the neighboring grid areas according to a ratio of the geographical distance to a location deviation threshold.

In some embodiments, the store deduplication processing apparatus may further include a second pre-processing module. The second pre-processing module may be configured to: obtain a store name of the existing store, and obtain store name information according to the store name; input the store name information of the existing store into the second model to obtain a store type probability vector of the existing store output by the second model; establish a second corresponding relationship between the existing store and the store type probability vector of the existing store, and save the second corresponding relationship in the existing store database.

A third aspect of the present application provides a store deduplication processing device. FIG. 7 is a schematic structural view of a store deduplication processing device provided in an embodiment of the present application. As shown in FIG. 7, the store deduplication processing device 400 includes a memory 401, a processor 402, and a computer program saved in the memory 401 and executable on the processor 402.

In some examples, the processor 402 may be a central processing unit (CPU) or an application specific integrated circuit (ASIC), or may be configured to implement one or more integrated circuits in the embodiments of the present application.

The memory 401 may be a read-only memory (ROM), a random access memory (RAM), a magnetic disk storage medium device, an optical storage medium device, a flash memory device, or an electrical, optical, or other physical/tangible memory device. Therefore, typically, the memory includes one or more tangible (non-transient) computer-readable storage media (such as memory devices) encoded with software including computer executable instructions, and the software, when executed (for example, by one or more processors), can perform the operation described with reference to the store deduplication processing method in the embodiments of the present application.

The processor 402 reads the executable program code stored in the memory 401 to run the computer program corresponding to the executable program code, so as to implement the store deduplication processing method in the above embodiments.

In some examples, the store deduplication processing device 400 may further include a communication interface 403 and a bus 404. As shown in FIG. 7, the memory 401, the processor 402, and the communication interface 403 are connected and communicate with each other through the bus 404.

The communication interface 403 is mainly configured to implement communication between various modules, apparatuses, units, and/or devices in the embodiments of the present application. Input and/or output devices can also be connected through the communication interface 403.

The bus 404 includes hardware, software, or both, and couples the components of the store deduplication processing device 400 together. By way of example and not limitation, the bus 404 may be an accelerated graphics port (AGP) or other graphics bus, an enhanced industry standard architecture (EISA) bus, a front side bus (FSB), a hyper transport (HT) interconnect, an industry standard architecture (ISA) bus, an infinite bandwidth interconnect, a low pin count (LPC) bus, a memory bus, a micro channel architecture (MCA) bus, a peripheral component interconnect (PCI) bus, a PCI-Express (PCI-E) bus, a serial advanced technology attachment (SATA) bus, a video electronics standards association local (VLB) bus, or any other suitable bus, or a combination of two or more of the above. Where appropriate, the bus 404 may include one or more buses. Although the embodiment of the present application describes and shows a specific bus, the present application considers any suitable bus or interconnect.

A fourth aspect of the present application further provides a computer-readable storage medium, storing computer program instructions that, when executed by a processor, can implement the store deduplication processing method in the above embodiments and achieve the same technical effects, which will not be described here in order to avoid repetition. The computer-readable storage medium may be a non-transient computer-readable storage medium, such as a read-only memory (ROM), a random access memory (RAM), a magnetic disk, or an optical disk.

Embodiments of the present application provides a computer program product, where instructions in the computer program product, when executed by a processor of an electronic device, enable the electronic device to perform the store deduplication processing method in the above embodiments and achieve the same technical effects, which will not be described here in order to avoid repetition.

It should be noted that the various embodiments in this specification are described in a progressive manner, the same or similar parts between the various embodiments may refer to each other, and each embodiment focuses on the differences from other embodiments. For the embodiments of the apparatus, the device, the computer-readable storage medium, and the computer program product, relevant parts can refer to the description section of the embodiments of the method. The present application is not limited to the specific steps and structures described above and shown in the figures. Those skilled in the art can make various changes, modifications, and additions, or change the order of steps after understanding the spirit of the present application. And, for the sake of simplicity, detailed descriptions of known methods and technologies are omitted here.

The above describes various aspects of the present application with reference to the flowchart and/or block view of the method, apparatus (system), and computer program product according to the embodiments of the present application. It should be understood that each box in the flowchart and/or block view and a combination of boxes in the flowchart and/or block view can be implemented by computer program instructions. These computer program instructions can be provided to a processor of a general-purpose computer, a dedicated computer, or other programmable data processing apparatuses to produce a machine, which enables the instructions executed by the processor of the computer or other programmable data processing apparatuses to implement the functions/actions specified in one or more boxes of the flowchart and/or block view. Such a processor may be, but is not limited to a general-purpose processor, a dedicated processor, a special application processor, or a field programmable logic circuit. It can also be understood that each box in the block view and/or flowchart and a combination of boxes in the block view and/or flowchart can be implemented by dedicated hardware that executes specified functions or actions, or by a combination of dedicated hardware and computer instructions.

Those skilled in the art should understand that the above embodiments are all illustrative but not restrictive. Different technical features appearing in different embodiments can be combined to achieve beneficial effects. Those skilled in the art should be able to understand and implement other modified embodiments of the disclosed embodiments after studying the drawings, description, and claims. In the claims, the term “comprise” does not exclude other apparatuses or steps; the quantifier “one” does not exclude more; and the terms “first” and “second” are used to denote names rather than to indicate any specific order. Any reference numerals in the claims should not be construed as limiting the scope of 10 protection. The functions of a plurality of portions appearing in the claims can be implemented by a single hardware or software module. The appearance of some technical features in different dependent claims does not mean that these technical features cannot be combined to achieve beneficial effects.

1. A store deduplication processing method, comprising:
obtaining a first store name and first store location information of a target store;
determining, according to the first store location information, a target grid area where the target store is located;
obtaining, from a pre-saved existing store database, a second store name and a second store location information of existing stores located in the target grid area and neighboring grid areas adjacent to the target grid area;
obtaining a target similarity between the target store and the existing stores located in the target grid area and the neighboring grid areas according to the first store name, the first store location information, the second store name, and the second store location information; and
removing the target store as a duplicate store in the case that the target similarity is greater than or equal to a preset deduplication similarity threshold.

2. The method according to claim 1, wherein each grid area has a grid code, and
before the obtaining, from a pre-saved existing store database, a second store name and second store location information of stores located in the target grid area and neighboring grid areas, the method further comprises:
obtaining the grid code of the target grid area;
obtaining location information of a vertex of the target grid area according to the grid code of the target grid area and an inverse grid coding algorithm;
determining location information of auxiliary points located in the neighboring grid areas according to the location information of the vertex of the target grid area; and
calculating the grid code of each of the neighboring grid areas according to the location information of the auxiliary points in the neighboring grid areas and a grid coding algorithm, to determine the neighboring grid areas.

3. The method according to claim 1, wherein each grid area has a grid code, values of some bits in grid codes of the neighboring grid areas are the same, and
before the obtaining, from a pre-saved existing store database, a second store name and second store location information of existing stores located in the target grid area and neighboring grid areas, the method further comprises:
obtaining the grid code of the target grid area;
obtaining the grid codes of candidate grid areas according to the grid code of the target grid area, the candidate grid areas comprising grid areas, some bits of characters in the grid codes of which are the same as those in the grid code of the target grid area; and
determining the grid codes of the neighboring grid areas from the grid codes of the candidate grid areas according to a corresponding relationship between an arrangement of the grid areas and the characters of code bits in the grid coding algorithm, to determine the neighboring grid areas.

4. The method according to claim 1, further comprising:
dividing a map into a plurality of grid areas, and assigning a grid code to each of the plurality of grid areas using the grid coding algorithm;
obtaining store location information of the existing store, and determining, according to the store location information of the existing store, the grid area where the existing store is located; and
establishing a first corresponding relationship between the existing store and the grid code of the grid area where the existing store is located, and saving the first corresponding relationship in the existing store database.

5. The method according to claim 1, wherein the obtaining a target similarity between the target store and the existing stores located in the target grid area and the neighboring grid areas according to the first store name, the first store location information, the second store name, and the second store location information comprises:
obtaining N name-related similarities between the target store and the existing stores located in the target grid area and the neighboring grid areas according to the first store name and the second store name, where N is an integer greater than or equal to 1;
obtaining a location similarity between the target store and the existing stores located in the target network area and the neighboring grid areas according to the first store location information and the second store location information; and
calculating the target similarity according to the N name-related similarities, the location similarity, and corresponding weight coefficients.

6. The method according to claim 5, wherein the name-related similarities comprise a character similarity, and
the obtaining N name-related similarities between the target store and the existing stores located in the target grid area and the neighboring grid areas according to the first store name and the second store name comprises:
segmenting the first store name and the second store name each to obtain terms corresponding to the first store name and terms corresponding to the second store name;
calculating term frequencies and inverse document frequencies of the terms corresponding to the first store name and the terms corresponding to the second store name;
selecting the terms with term frequencies less than or equal to a redundant term frequency threshold and inverse document frequencies greater than a redundant frequency threshold; and
obtaining, according to the selected terms corresponding to the first store name and the selected terms corresponding to the second store name, the character similarity between the target store and the existing stores located in the target grid area and the neighboring grid areas.

7. The method according to claim 5, wherein the name-related similarities comprise a semantic similarity, and
the obtaining N name-related similarities between the target store and the existing stores located in the target grid area and the neighboring grid areas according to the first store name and the second store name comprises:
transforming the first store name and the second store name into a first name digit sequence and a second name digit sequence respectively; and
inputting the first name digit sequence and the second name digit sequence into a first model, to obtain the semantic similarity between the target store and the existing stores located in the target grid area and the neighboring grid areas output by the first model, wherein the first model is used for outputting the semantic similarity between two store names according to the input digit sequences transformed from the two store names.

8. The method according to claim 5, wherein the name-related similarities comprise a store type similarity, and
the obtaining N name-related similarities between the target store and the existing store located in the target grid area and the neighboring grid areas according to the first store name and the second store name comprises:
obtaining the first store name information according to the first store name;
inputting the first store name information into a second model to obtain a store type probability vector of the target store output by the second model, wherein the second model is used for outputting a store type probability vector according to the input store name information, and the store type probability vector is used for representing a probability that the store indicated by the store name belongs to each store type;
searching in the stock database for a store type probability vector corresponding to the second store name; and
calculating a similarity between the store type probability vector of the target store and the store type probability vector corresponding to the second store name, and determining the similarity as the store type similarity between the target store and the existing store located in the target grid area and the neighboring grid areas.

9. The method according to claim 8, further comprising:
obtaining a store name of the existing store, and obtaining a store name information according to the store name;
inputting the store name information of the existing store into the second model to obtain a store type probability vector of the existing store output by the second model; and
establishing a second corresponding relationship between the existing store and the store type probability vector of the existing store, and saving the second corresponding relationship in the existing store database.

10. The method according to claim 5, wherein the obtaining a location similarity between the target store and the existing store located in the target network area and the neighboring grid areas according to the first store location information and the second store location information comprises:
obtaining a geographical distance between the target store and the existing store according to the first store location information and the second store location information; and
obtaining the location similarity between the target store and the existing store located in the target network area and the neighboring grid areas according to a ratio of the geographical distance to a location deviation threshold.

11. A store deduplication processing apparatus, comprising:
a first obtaining module, configured to obtain a first store name and first store location information of a target store;
a grid area determination module, configured to determine, according to the first store location information, a target grid area where the target store is located;
a second obtaining module, configured to obtain, from a pre-saved existing store database, a second store name and second store location information of an existing store located in the target grid area and neighboring grid areas adjacent to the target grid area;
a calculation module, configured to obtain a target similarity between the target store and the existing store located in the target grid area and the neighboring grid areas according to the first store name, the first store location information, the second store name, and the second store location information; and
a deduplication module, configured to remove the target store as a duplicate store in the case that the target similarity is greater than or equal to a preset deduplication similarity threshold.

12. A store deduplication processing device, comprising: a processor and a memory storing computer program instructions, wherein
the processor implements the store deduplication processing method when executing the computer program instructions, the store deduplication processing method comprising:
obtaining a first store name and first store location information of a target store;
determining, according to the first store location information, a target grid area where the target store is located;
obtaining, from a pre-saved existing store database, a second store name and a second store location information of existing stores located in the target grid area and neighboring grid areas adjacent to the target grid area;
obtaining a target similarity between the target store and the existing stores located in the target grid area and the neighboring grid areas according to the first store name, the first store location information, the second store name, and the second store location information; and
removing the target store as a duplicate store in the case that the target similarity is greater than or equal to a preset deduplication similarity threshold.

13. A computer-readable non-transient storage medium, storing computer program instructions that, when executed by a processor, implement the store deduplication processing method, the store deduplication processing method comprising:
obtaining a first store name and first store location information of a target store;
determining, according to the first store location information, a target grid area where the target store is located;
obtaining, from a pre-saved existing store database, a second store name and a second store location information of existing stores located in the target grid area and neighboring grid areas adjacent to the target grid area;
obtaining a target similarity between the target store and the existing stores located in the target grid area and the neighboring grid areas according to the first store name, the first store location information, the second store name, and the second store location information; and
removing the target store as a duplicate store in the case that the target similarity is greater than or equal to a preset deduplication similarity threshold.
